(19) United States
(12) Patent Application Publication
(10) Pub. No.: US 2003/0202081 A1
(43) Pub. Date: Oct. 30, 2003

(54) Apparatus for producing a printing form

(76) Inventors: Peter Marten, Heiligkreuzsteinach (DE); Rene Retizlaff, Westerronfeld (DE); Heino Schadwald, Felmerholz (DE); Gotthard Schmid, Malsch (DE)

Correspondence Address: LERNER AND GEENBERG, P.A., POST OFFICE BOX 2480, HOLLYWOOD, FL, 33022-2480, US

(21) Appl. No.: 10/425,446

(22) Filed: Apr. 29, 2003

Related U.S. Application Data
(60) Provisional application No. 60/377,280, filed on May 1, 2002.
(60) Provisional application No. 60/377,285, filed on May 2, 2002.

(30) Foreign Application Priority Data
Apr. 29, 2002 (DE) 102 19074.7

(51) Int. Cl. B41J 2/01

(52) U.S. Cl. 347/101

(57) ABSTRACT

An apparatus for producing a printing form includes a device for feeding a printing-form blank to a circumferential surface of a rotatable cylinder, a device for releasably fixing the printing-form blank to the circumferential surface, and a device for producing ink-accepting image points or pixels on the surface of the printing-form blank in accordance with a printing image. The pixel-producing device has a device for treating the printing-form blank with a medium stored in a container. The container is disposed so as to be movable relative to the cylinder.

### CROSS-REFERENCE TO RELATED APPLICATION

This application claims the benefit under 35 U.S.C. § 119(e) of copending provisional application Nos. 60/377,286, filed May 2, 2002, and 60/377,285, filed May 2, 2002.

### BACKGROUND OF THE INVENTION

### FIELD OF THE INVENTION

The invention relates to an apparatus for producing a printing form, such as a printing plate, which has a device for feeding a printing-form blank to a circumferential surface of a rotatable cylinder, a device for releasably fixing the printing-form blank to the circumferential surface, and a device for producing ink-accepting image points or pixels on the surface of the printing-form blank in accordance with a printing image. The pixel-producing device has a device for treating the printing-form blank with a medium stored in a container.

German Published, Non-Prosecuted Patent Application DE 32 39 580 A1, corresponding to U.S. Pat. No. 4,507,167, describes a device for changing printing film for a printing press, wherein previously imaged films are singly separated from a stacking or pile table by a suction roller and, with a transport device, are conducted through a stationary fixing container to a form cylinder. Following a printing operation, the film is guided into a storage device. A fixing liquid is received in the stationary fixing container. The fixing liquid or bath serves for making the previously imaged film ready for printing.

German Published, Non-Prosecuted Patent Application DE 29 42 772 A1, corresponding to U.S. Pat. No. 4,270,485, shows a liquid developer device wherein a medium conveyed on an endless belt is provided with a charge image and is subsequently moved over a developing bath. In this regard, liquid developer is conveyed to the developing bath by a pump. The liquid developer emerges with a gentle flow from interspaces between developing electrodes. The spent developer is guided back to a storage container via an outlet. The distance between the developing electrodes and the medium is set at a fixed value.

In a method for removing non-image areas from electro-photographic planographic printing plates disclosed in German Published, Non-Prosecuted Patent Application DE 39 33 156 A1, a processing fluid is provided which is stored in a stationary container. The impedance of the processing fluid is determined or registered by a sensor. Signals issuing from the sensor serve for deriving actuating signals which cause the processing fluid to be refilled by pumps. A planographic printing-plate blank is exposed to the processing fluid by spraying devices or in a dip processing zone.

In German Published, Non-Prosecuted Patent Application DE 32 44 870 A1, corresponding to U.S. Pat. No. 4,420,363, a single-bath etching device for processing a gravure printing plate is described, wherein an inspection solution is sprayed on a printing-plate blank in a test area. The process parameters for an etching machine are determined based upon measurable effects of the inspection liquid. In that way, it is possible to control the rotational speed of a plate or form cylinder whereon the gravure printing-plate or printing-form blank is accommodated.

A common factor in the heretofore-known structures of the prior art is that, by providing conveyor devices for the printing forms, and the fixed configuration of the processor baths, the structures become voluminous, expensive in terms of material and costs, and not very flexible. That applies in particular when printing-form blanks of different construction are to be treated with varying processes.

### SUMMARY OF THE INVENTION

It is accordingly an object of the invention to provide an apparatus for producing a printing form or plate, which overcomes the hereinafore-mentioned disadvantages of the heretofore-known devices of this general type and which affords a compact construction with great flexibility.

With the foregoing and other objects in view, there is provided, in accordance with the invention, an apparatus for producing a printing form, comprising a device for feeding a printing-form blank to a circumferential surface of a rotatable cylinder, a device for releasably fixing the printing-form blank to the circumferential surface, and a device for producing ink-accepting image points or pixels on the surface of the printing-form blank in accordance with a printing image. The pixel-producing device has a device for treating the printing-form blank with a medium stored in a container. The container is movable relative to the cylinder.

In accordance with another feature of the invention, the container is able to be brought up to the cylinder.

In accordance with a further feature of the invention, the container is disposed underneath the cylinder.

In accordance with an added feature of the invention, the medium stored in the container is a liquid.

In accordance with an additional feature of the invention, the container is positionable in a vertical direction. Thus, in an upper position of the container, the printing-form blank disposed on the cylinder is in contact with the liquid.

In accordance with yet another feature of the invention, the medium stored in the container is a powdery medium.

In accordance with yet a further feature of the invention, the apparatus further includes a device for discharging the printing form. The discharging device is disposed in horizontal direction on a side of the cylinder opposite to a side thereof whereon the feeding device is disposed.

In accordance with yet an added feature of the invention, the discharging device includes a magazine for accommodating at least two printing forms.

In accordance with yet an additional feature of the invention, the discharging device has a printing-form storage device that is swivellable about an axis extending parallel to the axis of rotation of the rotatable cylinder.

In accordance with still another feature of the invention, the apparatus further includes an endless belt for conveying the medium from the container to the surface of the printing form blank.

In accordance with still a further feature of the invention, the endless belt is a textile, absorbent, and driven belt guidable over deflection rollers and, in one sector of the circumferential surface, is looped around the printing form blank for being set on and set off the printing form blank.

In accordance with still an added feature of the invention, one of the deflection rollers is positionable in a direction tangential to the cylinder.

In accordance with still an additional feature of the invention, the container is formed with different chambers separated from one another and filled with liquids. The belt dips into the liquid in one of the chambers.

In accordance with another feature of the invention, at least one of the container and the belt is positionable in horizontal direction and possibly in vertical direction for moving to a predetermined chamber.

In accordance with a further feature of the invention, the belt is guidable over at least one roller that is rotatably mounted on the container.

In accordance with a concomitant feature of the invention, the container, the cylinder and the pixel-producing device for accepting printing ink are integrated into a printing press.

According to the invention, the container is disposed so as to be movable relative to a printing-form cylinder. Imaging technology and equipment for print preparation are thereby present in only one device. The apparatus according to the invention needs only little overall space. With the movable container, all the fluids and media utilized for the print preparation can be provided for application to the printing-form blank. A printing form or plate in a clamping device is therefore made completely ready for use in a printing press.

A compact construction can be achieved due to the possibility that the container with the medium for treating a printing-form blank can be guided up to the printing-form cylinder. The apparatus can be constructed for treating conventional printing-plate blanks or sleeve-shaped printing form blanks. In this regard, the apparatus may be formed of modules which implement individual process steps. Such process steps are, for example, infeeding the printing-form blank for clamping it onto the cylinder, imaging or forming an image on the printing-form blank, aftertreating the imaged printing-form blank, releasing it from the cylinder, and removing it again. The modules and the functions thereof can be respectively connected up in accordance with the differently performable process steps. Depending upon the requirements of the respective process step, process media and/or cleaning media, such as liquids, pastes or powders, can be brought up in one or more containers to the printing-form blank. The apparatus can serve for treating various types of printing-form blanks for wet and dry offset printing. For example, if required, a silicone-coated printing-form or printing-plate blank for dry offset printing can be imaged, i.e., have an image formed thereon, and then aftertreated by mechanical devices, or a printing plate for wet offset printing can be treated chemically and subsequently washed with water. Such an apparatus can be set up and operated in a printshop or press room. It is possible to integrate the apparatus into a printing press, in particular an offset printing press. The printing-plate blank or printing-form blank can be processed and developed, respectively, on the cylinder, making it possible to process a printing-form blank which has already been edge-bent, in that it is then imaged and made ready for printing in a clamping device. Making ready for printing includes processes such as developing, drying and burning in the image on a printing-form blank. When erasable and rewriteable printing forms are used, the apparatus can additionally include an erasing device for erasing the imaging that had been produced for a previous print job.

The container with the medium can advantageously be disposed for movement in the vertical direction underneath the printing-form cylinder. A plurality of containers with various media can be provided, or one container with chambers, wherein various media are stored. The level of the medium in the container or in the chambers can be monitored and regulated or controlled. In the construction of a container with chambers, the latter can be positioned in vertical and horizontal direction so that the printing form located on the printing-form cylinder dips partly into the medium. A device for discharging a treated printing-form blank can be disposed on the opposite side of a feeding device. It is advantageous for the discharge device to include a magazine for accommodating at least two printing forms. A printing-form storage that is swivellable about an axis extending parallel to the axis of rotation of the cylinder can be provided in the discharge device.

By providing an endless belt for conveying a medium from a container to the surface of a printing-form blank, a compact construction can likewise be achieved. The belt can be formed of a textile, absorbent material and can be guided over deflection rollers in a manner that the belt loops or wraps around a sector of the circumferential surface of the Printing-form blank. If one of the deflection rollers is positionable, the belt can be set on and off the circumferential surface. In one embodiment, the container can have chambers which are filled with different liquids. By positioning the container, the belt can selectively dip into the liquid in one of the chambers.

Other features which are considered as characteristic for the invention are set forth in the appended claims.

Although the invention is illustrated and described herein as embodied in an apparatus for producing a printing form, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of an embodiment of the apparatus according to the invention for producing a printing form, having a vertically adjustably movable processor bath;

FIG. 2 is a view similar to FIG. 1 showing another embodiment of the apparatus according to the invention, having a fully automatic printing-form discharge device;

FIG. 3 is a further view similar to FIG. 1 showing a further embodiment of the apparatus according to the invention, having an automatic printing-form depositing device and an integrated plate cleaning device;

FIG. 4 is an additional view similar to FIG. 1 showing an additional embodiment of the apparatus according to the invention, having a device for applying and removing material capable of being exposed;

FIG. 5 is yet another view similar to FIG. 1 showing yet another embodiment of the apparatus according to the invention, provided with a double-chambered container;

FIG. 6 is yet a further view similar to FIG. 1 showing yet a further embodiment of the apparatus according to the invention, having a flexible belt and a horizontally adjustable processor bath; and

FIG. 7 is yet an additional view similar to FIG. 1 showing yet an additional embodiment of the apparatus according to the invention, provided with a triple-chambered container.

### DESCRIPTION OF THE PREFERRED EMBODIMENTS

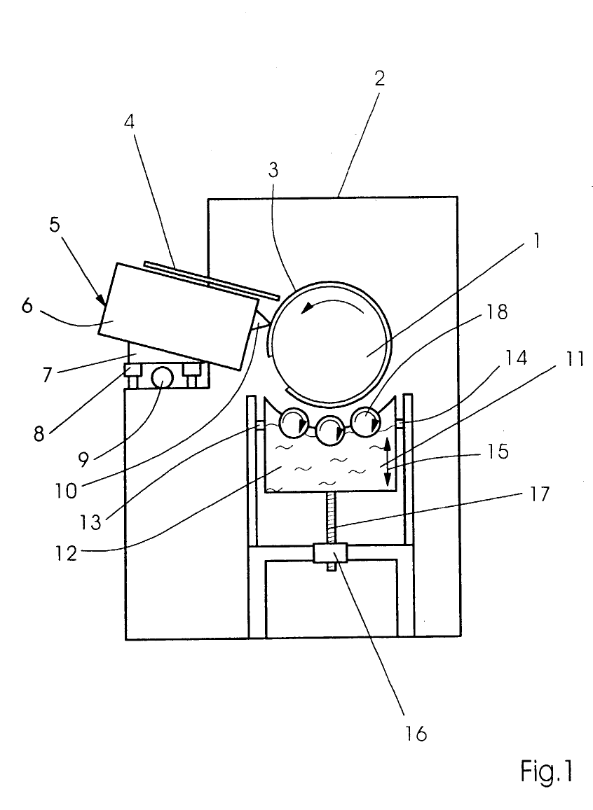

Referring now to the figures of the drawings in detail and first, particularly, to FIG. 1 thereof, there is seen a diagrammatic view of an embodiment of an apparatus for producing a printing form, wherein a printing-form cylinder 1 is rotatably mounted between side walls 2, only one of which is shown. Non-illustrated conventional devices for holding and clamping a printing-form blank 3 on an outer cylindrical or circumferential surface of the cylinder 1 are provided on the printing-form cylinder 1. These conventional devices may include mechanical clamping devices, which act upon ends of the printing-form blank 3, or devices making use of a technology based upon vacuum, which act over the entire area of the printing-form blank 3. An electric motor may be provided in order to drive the printing-form cylinder 1. The setting or position of the rotational angle of the printing-form cylinder 1 is registered by a rotary encoder. An inclined or obliquely-set placement and guide table 4 is provided for placement of printing-form blanks manually. The printing-form blanks can be fed by hand in such a manner that they meet the device for holding and clamping at the end of the placement and guide table 4. Underneath the placement and guide table 4, there is an imaging unit 5 including an imaging head 6, an oblique support 7, a linear guide 8 and a worm or spindle drive 9. The imaging unit 5 contains an array of individually activatable lasers having beams 10 which are directed towards the surface of the printing-form blank 3. The imaging unit 5 can be positioned in a direction parallel to the axis of rotation of the printing-form cylinder 1 by the linear guide 8 and the worm drive 9, so that the beams 10 can reach the entire surface to be imaged on the printing-form blank 3. A container 11 with a processor bath 12 is disposed underneath the printing-form cylinder 1.

The container 11 is positionable in a vertical direction represented by a double-headed arrow 15, in guides 13 and 14 belonging to the side walls 2, by a motor 16 and a spindle or screw 17. Either a gear or chain drive, which is coupled with an electric motor, can be provided for displacing the container 11 vertically. The vertical positioning of the container 11 can be controlled based upon the thickness of the printing-form blank 3, for which purpose appropriate detectors for the height of the container 11 are provided. Rollers 18, which are rotatably mounted between the side walls of the container 11, are provided in an upper region of the container 11. The rollers 18 are aligned parallel with the axis of rotation of the printing-form cylinder 1 and can be set against the surface of the printing-form blank 3. For this purpose, the rollers 18 can be spring-mounted on the container 11. The rollers 18 extend over the entire length of the printing-form cylinder 1, and dip into the liquid in the processor bath 12. Depending upon what is required, the liquid of the process bath 12 or the entire container 11 can be provided in such a way as to be replaceable. The level of the liquid in the processor bath 12 can be regulated.

In order to produce a finished printing form, a printing-form blank 3 with a photosensitive layer can be brought onto the placement and guide table 4 and moved forward in a direction towards the form cylinder 1 to such an extent that the holding device on the printing-form cylinder 1 grips the leading edge of the printing-form blank 3. During rotation of the printing-form cylinder 1, the printing-form blank 3 is placed around the circumferential surface of the printing-form cylinder 1. The rear or trailing end of the printing-form blank is likewise held by a holding device. By applying a tensile stress between the holding devices at the leading and trailing edges of the printing-form blank 3, the latter is clamped smoothly onto the circumferential surface of the printing-form cylinder 1. The imaging unit 5 is then started up. While the printing-form cylinder 1 rotates, and the imaging unit 5 is positioned in the axial direction, the lasers are switched on and off in accordance with a printing image. During imaging, the rollers 18 of the container 11 are set off the surface of the printing-form blank 3. The beams 10 produce printing ink-accepting or dampening solution-accepting points or pixels by removal or changes in the adhesive characteristics of the photosensitive layer. After the imaging operation, the imaging unit 5 is movable into a parked position, and protective devices for optical elements become effective. For this purpose, the imaging unit 5 is movable away from the printing-form cylinder 1. In a further step, the height of the container 11 is adjusted so that the rollers 18 come to rest on the surface of the printing-form blank 3. While the printing-form cylinder 1 rotates, the rollers 18 are entrained or carried along by friction. In order to clean the printing-form blank 3, the rollers 18 serve for scooping liquid 12 out of the container 11 to the surface of the printing-form blank 3. Due to contact with the liquid 12, particles which are produced by the removal operation during the imaging are removed from the surface of the printing-form blank 3. The printing form is therefore produced ready to print and can be removed from the printing-form cylinder 1. Depending upon the requirements of the process, the liquid 12 in the container 7 is adjusted with respect to the composition and the characteristics thereof. For example, in addition to the cleaning action described hereinabove, the liquid 12 can display a developer action, so that points or pixels exposed by the beams 10 or unexposed points or pixels go into solution. One variant or different embodiment includes a photosensitive layer which is applied to the surface of a printing-form blank 3 before imaging, for which purpose the container 11 filled with photosensitive material and having the rollers 18 is moved against or into contact with the printing-form cylinder 1.

In the following description, elements having a function equivalent to that already described in relation to FIG. 1 are identified by the same reference numerals.

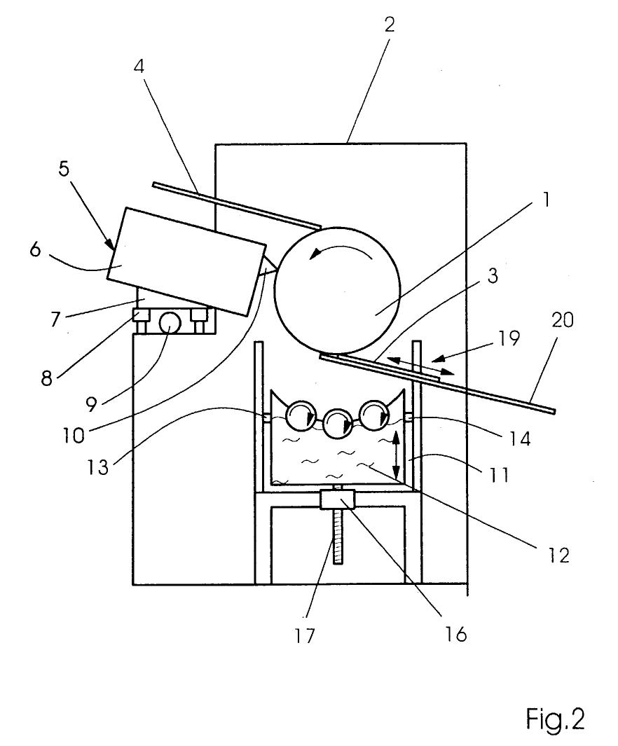

FIG. 2 illustrates a different embodiment or variant of the device for removing the printing-form blank 3 from the apparatus for producing a printing form. Following the imaging and cleaning of a printing-form blank 3, the container 11 is moved downwardly, so that there is sufficient clearance for a removal device 19 underneath the printing-form cylinder 1. The removal device 19 is provided with guide elements 20 for the printing-form blanks 3, so as to ensure that no damage to the imaging occurs during the conveyance of the finished printing forms. The removal of a finished printing form from the printing-form cylinder 1 can be carried out fully automatically. For this purpose, the holding and clamping devices on the printing-form cylinder 1 are released. By rotating the printing-form cylinder 1, the completely finished printing form is conveyed outwardly along the guide elements 20. It is possible to convey the printing form into a magazine which is constructed for accommodating a set of printing forms for one printing image. The delivery of a printing form on the rear side of the apparatus for producing a printing form can be carried out at the same time as a new printing-form blank 3 is supplied on the placement and guide table 4 oppositely disposed on the front side of the apparatus.

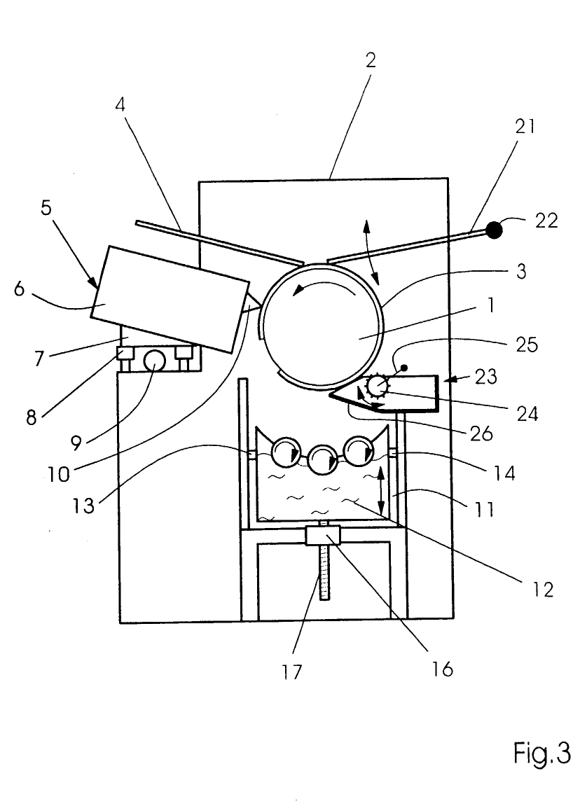

FIG. 3 illustrates a further different embodiment or variant of the apparatus for producing a printing form. As in FIG. 2, the container 11 is in a lower position, moved away from the printing-form cylinder 1. In order to deliver completely finished imaged printing forms, a pivotable printing-form storage 21 is provided on the rear side of the apparatus. The pivot axis 22 of the storage 21 extends parallel to the axis of rotation of the printing-form cylinder 1 and is coupled with the side walls 2. In a pivoted-in state, the printing plate storage 21 is located at least approximately tangentially to the printing-form cylinder 1. In this position, a completely finished printing form can automatically be conveyed from the surface of the printing-form cylinder 1 onto the printing-form storage 21. The ability to pivot permits adaptation to different thicknesses of the printing forms, improved removal by hand and accessibility to the interior of the apparatus for servicing when necessary. In this embodiment or variant of the apparatus according to the invention, a replaceable cleaning module 23 with a rotating brush 24 is additionally provided. The brush 24 is disposed on a swivelling lever 25, which permits the brush 24 to be set on and off the printing-form blank 3. The particles removed from the surface of the printing-form blank 3 by the brush 24 are sucked away, a guard 26 preventing the particles from contaminating the liquid 12 in the container 7.

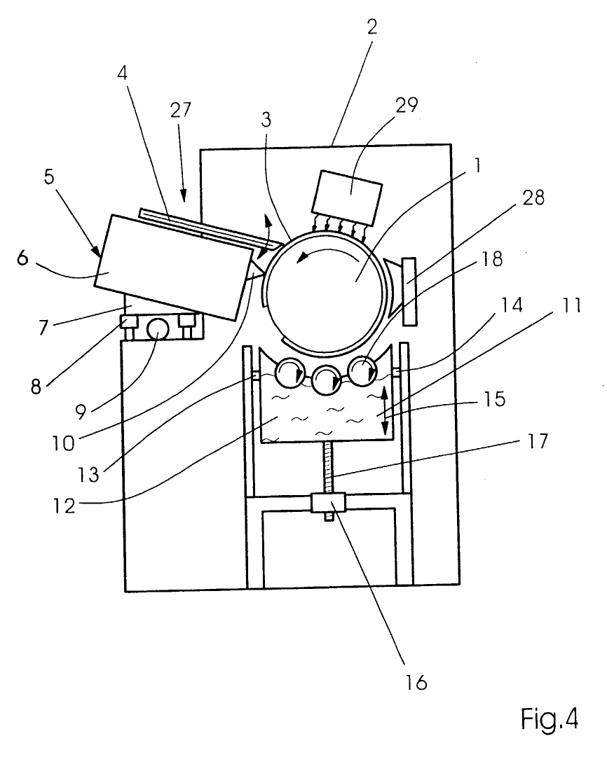

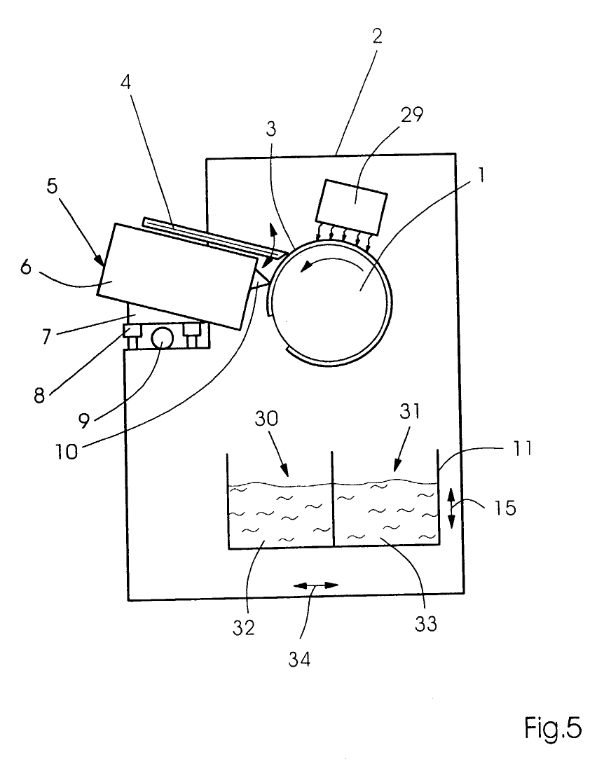

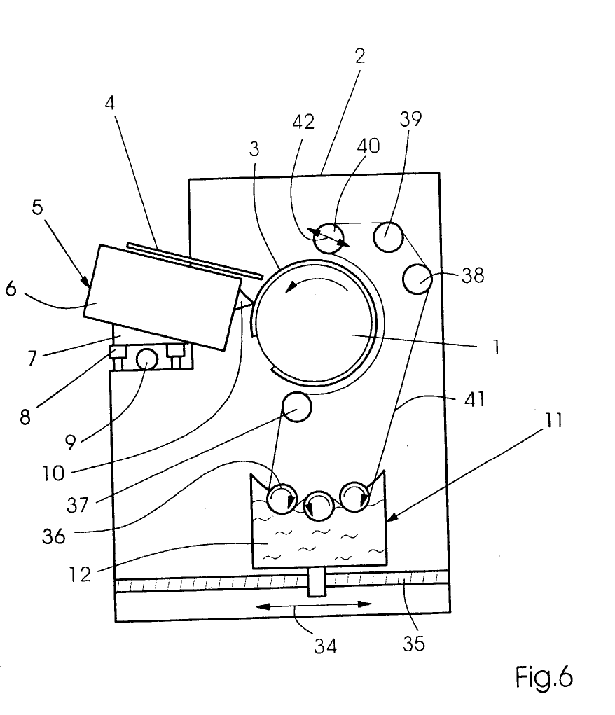

FIG. 4 shows an added different embodiment or variant of the apparatus according to the invention, provided with a semiautomatic printing-form feeder 27. In this different embodiment or variant, a series of printing-form blanks 3 can be made-ready in a magazine. This can be done while a printing-form blank 3 is being treated in the apparatus. The printing-form blanks 3 which are provided are removed automatically from the magazine and fed to the printing-form cylinder 1. A respective removal slot on the magazine lies at least approximately tangentially to the printing-form cylinder 1. The magazine is constructed to be pivotable or swivellable, in order to move the respective removal slot into the removal position. In the different embodiment or variant according to FIG. 4, a coating module 28 is also provided. The coating module 28 serves for applying materials capable of being exposed before they are imaged, if the intention is not to use a previously prepared printing-form blank 3. The container 11 with the rollers 18 acts as a developer and cleaning device here, the container 11 being filled with developer and cleaning liquid. A dryer module 29 serves for curing material capable of being exposed and/or for the thermal aftertreatment of the printing-form blank 3. For the case wherein sleeve-shaped printing-form blanks 3 are to be used, at least one opening is provided in a side wall in order to feed and remove the sleeve-shaped printing-form blanks 3. A special feature of the different embodiment or variant of the apparatus according to FIG. 5 is in the provision of the container 11 with two chambers 30 and 31 with different liquids 32 and 33. The liquids 32 and 33 can be photosensitive materials, developer liquid, fixing liquid or cleaning liquid. According to this variant embodiment, the container 11 can be positioned both in the vertical direction 15 and in the horizontal direction 34. The container 11 is positioned automatically based upon the type of printing form to be produced, the characteristics of which are entered into the control system of the apparatus beforehand in the form of data or are determined in advance by sensors. Following the selection of the required horizontal position, the container 11 is moved in the vertical direction 15 so that the printing-form blank 3 dips into the chamber 30 or 31 having the correct liquid 32 or 33 therein. As shown, for example, in FIG. 6, the container 11 can be positioned in the horizontal direction 34, in guides belonging to the side walls 2, by a motor and a worm or spindle 35. In an upper region of the container 11, rollers 36 are provided, which are rotatably mounted between the sidewalls of the container 11. The rollers 36 extend over the entire length of the printing-form cylinder 1. The rollers 36 are aligned parallel to the axis of rotation of the printing-form cylinder 1. The rollers 36 dip into the liquid in the processor bath 12. Depending upon the requirement, the liquid of the processor bath 12 or the entire container 11 can be provided so as to be replaceable. The level of the liquid in the processor bath 12 can be regulated. The apparatus further has a series of deflection rollers 37 to 40, which are mounted in the side walls 2. A textile absorbent belt 41 is placed around the rollers 36 in the container 11 and around the deflection rollers 37 to 40. The deflection roller 40 is constructed so as to be adjustable in the tangential direction 42 of the printing-form cylinder 1, in order to be able to set the belt 41 on and off the surface of the printing-form blank 3.

During the imaging operation by the imaging unit 5, the belt 41 is set off the surface of the printing-form blank 3. The beams 10 produce printing ink-accepting or dampening solution-accepting points or pixels due to removal or changes in the adhesive characteristics of the photosensitive layer. Following the imaging operation, the imaging unit 5 can be moved into a parked position, protective devices for optical elements then becoming effective. For this purpose, the imaging unit 5 can be moved away from the printing-form cylinder 1. In a further step, by positioning the deflection roller 40, the belt 41 is set on the surface of the printing-form blank 3. The belt 41 impregnated with cleaning liquid is moved over the surface of the printing-form blank 3 at a differential speed with respect to the rotating form cylinder 1. For this purpose, at least one of the deflection rollers 37 to 40 is driven. Due to the action of the cleaning liquid and due to the mechanical wiping action of the belt 41, particles which have been produced during imaging with the imaging unit 5 are removed from the surface of the printing-form blank 3. As the belt 41 passes through the container 11, the particles are surrendered to the cleaning liquid, the belt 41 picking up fresh cleaning liquid. The positioning of the container 11 in the horizontal direction 34 permits the tension of the belt 41 to be controlled, and movement to a service position for replacing the container 11 or the liquid 12. The finished printing form has thus been produced ready for printing and can be removed from the printing-form cylinder 1. Depending upon the requirements of the process, the liquid 12 in the container 11 is set or adjusted with respect to the composition and characteristics thereof. For example, the liquid 12, in addition to the cleaning action described hereinabove, can provide a developer action, so that points or pixels exposed by the beams 10 or unexposed points or pixels go into solution.

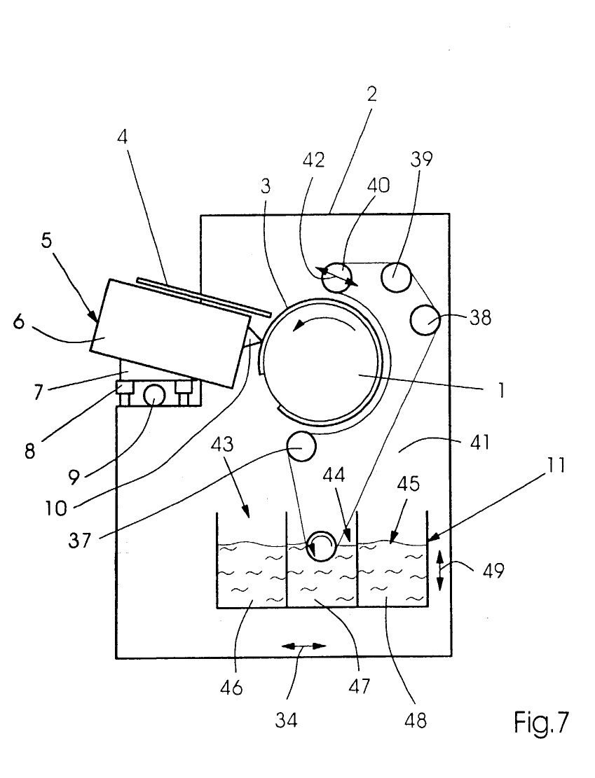

A special feature of the different embodiment or variant of the apparatus according to FIG. 7 is in the construction of the container 11 with three chambers 43, 44 and 45 with different liquids 46, 47 and 48, respectively, disposed therein. The liquids 46 to 48 can be photosensitive materials, developer liquid, fixing liquid or cleaning liquid. According to this different embodiment or variant, the container 11 can be positioned both in the vertical direction 49 and in the horizontal direction 34. The container 11 is positioned automatically based upon the type of printing form to be produced, the characteristics of which are entered in advance into the controls of the device in the form of data or are determined in advance by sensors. Following the selection of the required horizontal position, the container 11 is moved in the vertical direction 49 so that the printing-form blank 3 dips into one of the chambers 43 to 45 containing the correct liquid 46 to 48, respectively.

The aforedescribed variants or different embodiments constitute only exemplary embodiments, which can be modified and combined as desired. The apparatus can be quite compact, requiring a small area for the erection thereof, so that it is possible to provide the apparatus in a pressroom or print shop, and it being therefore possible for the operation of the apparatus to be performed from the operating desk of a printing press. In the control of the apparatus, use may be made of data which is also used in controlling the printing press. The apparatus is suitable for processing all types of printing forms, such as rewriteable printing forms, conventional aluminum plates, printing forms in film or sleeve form, precoated printing forms, and printing forms which are coated and cleaned in the apparatus. The apparatus can be integrated into printing units of a printing press.

We claim:

1. An apparatus for producing a printing form, the apparatus comprising:
a device for feeding a printing-form blank to a circumferential surface of a rotatable cylinder;
a container for storing a medium, said container being movable relative to said cylinder;
a device for releasably fixing the printing-form blank to the circumferential surface; and
a device for producing ink-accepting image points or pixels on a surface of the printing-form blank in accordance with a printing image, said pixel-producing device having a device for treating the printing-form blank with said medium.

2. The apparatus according to claim 1, wherein said container is to be brought up to said cylinder.

3. The apparatus according to claim 1, wherein said container is disposed underneath said cylinder.

4. The apparatus according to claim 1, wherein said medium stored in said container is a liquid.

5. The apparatus according to claim 4, wherein said container is to be positioned in a vertical direction into an upper position in which said printing-form blank disposed on said cylinder is in contact with said liquid.

6. The apparatus according to claim 1, wherein said medium stored in said container is a powdery medium.

7. The apparatus according to claim 1, wherein said feeding device is disposed on a given side of the cylinder, and a device for discharging the printing form is disposed in horizontal direction on a side of the cylinder opposite to said given side.

8. The apparatus according to claim 7, wherein said discharging device includes a magazine for accommodating at least two printing forms.

9. The apparatus according to claim 7, wherein the rotatable cylinder has an axis of rotation, and said discharging device has a printing-form storage device to be swiveled about an axis extended parallel to the axis of rotation of the rotatable cylinder.

10. The apparatus according to claim 1, further comprising an endless belt for conveying said medium from said container to the surface of the printing-form blank.

11. The apparatus according to claim 10, further comprising deflection rollers, said endless belt being a textile, absorbent and driven belt to be guided over said deflection rollers and being looped around the printing-form blank for being set on and set off the printing-form blank in one sector of the circumferential surface.

12. The apparatus according to claim 11, wherein one of said deflection rollers is to be positioned in a direction tangential to the cylinder.

13. The apparatus according to claim 10, wherein said container has different chambers separated from one another and each filled with a liquid, said belt dipping into the liquid in one of said chambers.

14. The apparatus according to claim 10, wherein said container is to be positioned in one of horizontal and vertical direction for moving to a predetermined chamber.

15. The apparatus according to claim 10, wherein said belt is to be positioned in one of horizontal and vertical direction for moving to a predetermined chamber.

16. The apparatus according to claim 10, wherein said container and said belt are to be positioned in one of horizontal and vertical direction for moving to a predetermined chamber.

17. The apparatus according to claim 10, further comprising at least one roller rotatably mounted on said container, said belt to be guided over said at least one roller.

18. The apparatus according to claim 1, wherein said container, the cylinder and said pixel-producing device for accepting printing ink are integrated into a printing press.
